(19) United States
(12) Patent Application Publication
(10) Pub. No.: US 2008/0301350 A1
(43) Pub. Date: Dec. 4, 2008

(54) Method for Reassigning Root Complex Resources in a Multi-Root PCI-Express System

(76) Inventors: Chad J. Larson, Austin, TX (US); Ricardo Mata, Pflugerville, TX (US); Michael A. Perez, Cedar Park, TX (US); Steven Vongvibool, Austin, TX (US)

Correspondence Address: HAMILTON & TERRILE, LLP;IBM Austin, P.O. BOX 203518, AUSTIN, TX, 78720, US

(21) Appl. No.: 11/755,882

(22) Filed: May 31, 2007

(51) Int. Cl. G06F 13/20

(52) U.S. Cl. 710/313

(57) ABSTRACT

A system for reassigning root complex resources in a multi-root PCI express system identifies resources from a lower performing root complex port and reassigns those resources to the higher performing root complex. The system does not change the number of PCI Express lanes, the resources each root complex uses may be reassigned to allow those resources to be translated to available credits for an endpoint. For example, in one embodiment, two root complexes are configured as x8 root complexes with the root complex resources distributed across the two root complexes based upon the usage of the root complex resources.

### BACKGROUND OF THE INVENTION

1. Field of the Invention

The present invention relates in general to the field of computers and similar technologies, and in particular to software utilized in this field. Still more particularly, the present invention relates to reassigning root complex resources in a multi-root PCI express system.

2. Description of the Related Art

The Peripheral Component interconnect Express (PCI Express or PCIe) protocol is rapidly establishing itself as the successor to the PCI protocol. When compared with PCI systems (i.e., legacy PCI), PCI Express systems provide higher performance, increased flexibility and scalability for next-generation systems, while maintaining software compatibility with existing PCI applications widely deployed in computer, storage, communications and general embedded systems.

PCI Express provides a high-speed, switched architecture. Each PCI Express link is a serial communications channel. In certain systems up to 32 of these channels (i.e., lanes) may be combined in x2, x4, x8, x16 and x32 configurations, creating a parallel interface of independently controlled serial links. The bandwidth of the switch backplane determines the total capacity of a PCI Express system. Compared to the legacy PCI protocol, the PCI Express protocol is considerably more complex, with three layers, a transaction layer, a data link layer and a physical layer.

In a PCI Express system, a root complex device couples the processor and memory subsystem to a PCI Express switch fabric comprised of one or more switch devices. Similar to a host bridge in a PCI system, the root complex generates transaction requests on behalf of the processor, which is interconnected through a local bus. Root complex functionality may be implemented as a discrete device, or may be integrated with the processor. A root complex may contain more than one PCI Express port and multiple switch devices can be connected to ports on the root complex or cascaded. FIG. 1, labeled Prior Art, shows a block diagram an exemplative PCI Express system.

One issue relating to PCI express is that input/output (IO) integrated circuit chips that implement the PCI Express protocol have a limited amount of internal resources that can be set a side for a PCI Express implementation. Many known IO integrated circuit chips, especially at the high end, provide multiple root complexes versus single root complexes. In known integrated circuit chips, the resources set aside for root complexes is typically divided evenly across the root complexes. With multiple root complexes, often some of the root complexes are not used or are used sparingly.

When some root complex resources are highly used, additional root complex resources can be added to each Root Complex. However, such a solution increases the cost and real estate used within the integrated circuit. Adding additional resources often requires adding extra memory and other logic to the integrated circuit. The added real estate can also result in a more expensive, complex and larger chip package. Another option is to remove root complexes or other function from the integrated circuit chip.

Accordingly, known integrated circuit chips are provided with a limited amount of PCI-Express resources per root complex. For example, each root complex may only allow 8 outstanding posted and 8 outstanding non-posted headers and may only allow 2k of write bandwidth and 4k of read bandwidth. The amount of resources a root complex provides per port is passed to the adapter attached to that port via flow control credit updates. The adapter can only request what the root complex can support. The performance of a particular endpoint attached to a root complex is limited by the availability of credits and buffer space.

The problem is that we could have situations where a very high end adapter card is off one Root Complex. And a very low end adapter card is off another Root Complex. Each Root Complex is the same lane size and has the same credits. The high end card does not reach its maximum performance due to Root Complex. Limitations where as the Low End Card meets its needs with only a fraction of the available Root Complex. Credits needed.

It is known to provide a bifurcation function with root complexes. With a bifurcation function, two x8 root complexes are combined to provide a single x16 root complex.

### SUMMARY OF THE INVENTION

In accordance with the present invention, resources from unused or lightly used root complexes are reassigned to other root complexes. More specifically, a system for reassigning root complex resources in a multi-root PCI express system identifies resources from a lower performing root complex port and reassigns those resources to the higher performing root complex. The system does not change the number of PCI Express lanes, the resources each root complex uses may be reassigned to allow those resources to be translated to available credits for an endpoint. For example, in one embodiment, two root complexes are configured as x8 root complexes with the root complex resources distributed across the two root complexes based upon the usage of the root complex resources.

A system for reassigning root complex resources in accordance with the present invention advantageously maximizes the performance for high end adapter cards as well as maximizing overall system bandwidth. Without such a system, the upper end of system performance can be limited.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1, labeled Prior Art, shows a block diagram of an exemplative PCI Express system

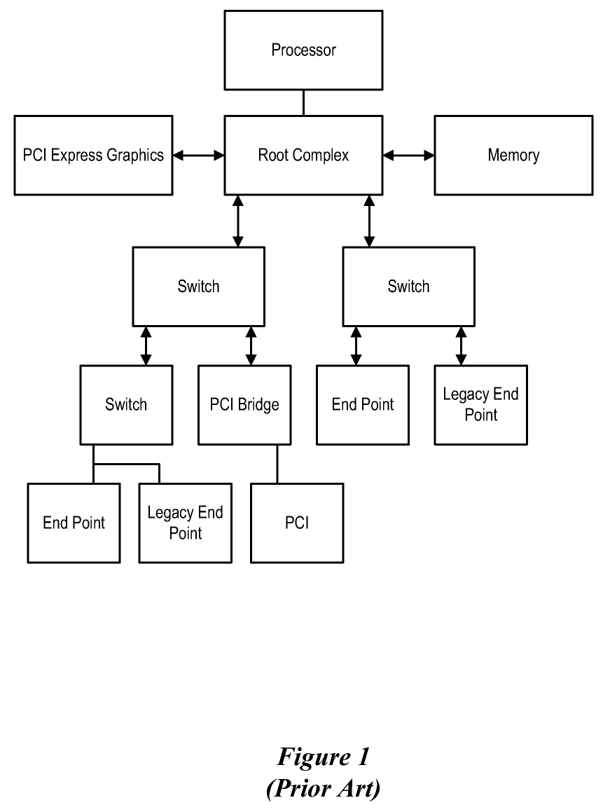

FIG. 2 shows a block diagram of a PCI Express server system in accordance with the present invention.

FIG. 3 shows a block diagram of a root complex.

FIG. 4 shows a flow chart of the operation of a system for reassigning root complex resources.

FIG. 5 shows a flow chart of the operation of an initialization operation of an initialization portion of a system for reassigning root complex resources.

FIG. 6 shows a flow chart of the operation of a counter based dynamic rebalance operation of a system for reassigning root complex resources.

FIG. 7 shows a flow chart of the operation of a percentage based dynamic rebalance operation of a system for reassigning root complex resources.

### DETAILED DESCRIPTION

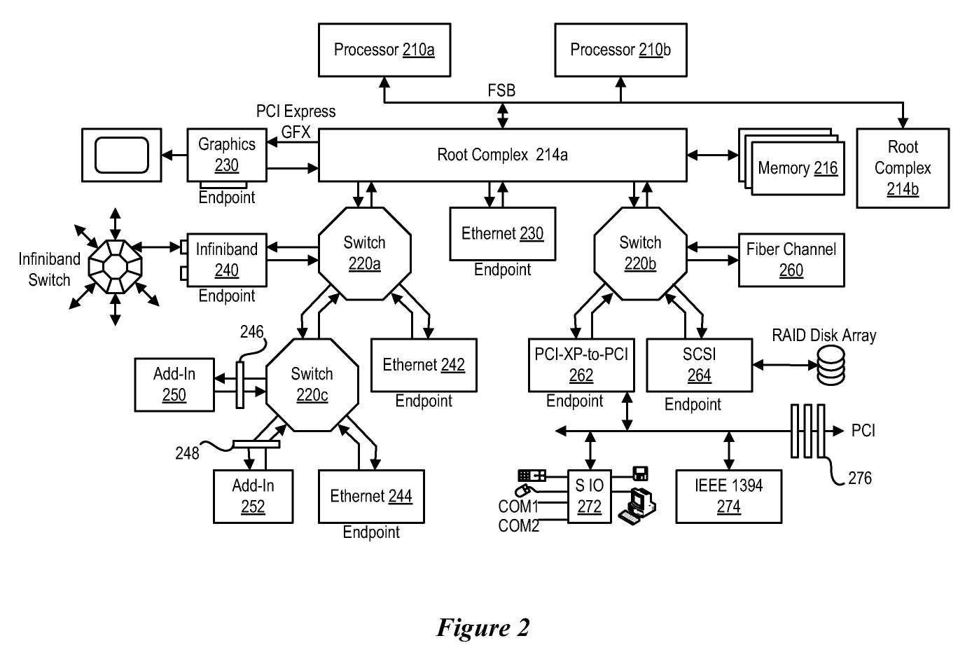

Referring to FIG. 2, a block diagram of a PCI Express server system 200 is shown. More specifically, the PCI Express server system 200 includes a plurality of processors 210a, 210b which are coupled via a local bus 212 to a plurality of root complexes 214a, 214b. The root complexes 214a, 214b are in turn coupled to memory 216 (e.g., synchronous dynamic random access memory (SDRAM)) as well as a plurality of switches 220a, 220b. The root complexes 214a, 214b are also respectively coupled to one or more endpoints.

The endpoints may be, for example, a graphics device 230, or an Ethernet device 232. The switches 220a, 220b are also coupled to either other switches 220c or other endpoints. For example, switch 220a is shown coupled to an infiniband endpoint 240, switch 220c, and Ethernet device endpoints 242, 244. The switch 220 may also be coupled to slots 246, 248 into which additional PCI Express add in devices 250, 252 may be respectively inserted and thus added to the system 200. Also for example, switch 220b is shown coupled to a fiber channel device 260 as well as a PCI express to PCI bridge 262 and a small computer system interface (SCSI) module 264 (each of which function as endpoints).

The PCI bridge 262 is in turn coupled to a plurality of PCI devices via a PCI bus 270. For example, the PCI bridge 262 is shown coupled to a PCI based system input output (SIO) module 272 and an IEEE 1394 module 274 as well as a plurality of PCI slots 276 into which additional PCI devices may be inserted. The SCSI module 262 is coupled to a disk storage device 278 (e.g., a redundant array of inexpensive disks (RAID) disk array)

The root complex 214a, 214b is the device that connects the processors and memory sub-systems to the PCI Express fabric. Each root complex 214 may support one or more PCI Express ports. The root complex 214a in this example supports 3 ports. Each port is connected to an endpoint device or a switch which forms a sub-hierarchy. The root complex 214 generates transaction requests on behalf of the processors 210. The root complex 214 is capable of initiating configuration transactions requests on behalf of the processors 210. The root complex 214 generates both memory and IO requests as well as generates locked transaction requests on behalf of the processors 210. The root complexes 214a, 214b transmit packets out of their respective ports and receive packets on their respective ports which are then forwards to memory. A multi-port root complex may also route packets from one port to another port.

Each root complex 214 implements central resources such as hot plug, controller, power management controller, interrupt controller, error detection and reporting logic. The root complex initiates with a bus number, device number and function number which are used to form a requester ID or completer ID. The root complex bus, device and function numbers initialize to all zeros.

The PCI Express protocol provides a high speed high performance point to point dual simplex differential signaling link for interconnecting devices (a link). A hierarchy is a fabric of all the devices and links associated with a root complex 214 that are either directly connected to the root complex 214 via the ports of the root complex 214 or indirectly connected via switches 220 or bridges (e.g., PCI Express to PCI bridge 262). In system 200, the entire PCI Express fabric associated with the root complex 214a is one hierarchy. A hierarchy domain is a fabric of devices and links that are associated with one port of the root complex. For example, in system 200, there are three hierarchy domains associated with the hierarchy of the root complex 214a.

Endpoints are devices other than root complexes 214 and switches 220 that are requesters or completers of PCI Express transactions. They are peripheral devices such as Ethernet, USB or graphics devices. Endpoints initiate transactions as a requester or respond to transactions as a completer. Two types of endpoints exist, PCI Express endpoints and legacy endpoints. Legacy endpoints may support IO transactions. Legacy endpoints may support locked transaction semantics as a completer but not as a requester. Interrupt capable legacy devices may support legacy style interrupt generation using message requests but must in addition support MSI generation using memory write transactions. Legacy devices do not necessarily support 64-bit memory addressing capability. PCI Express Endpoints do not support IO or locked transaction semantics and support MSI style interrupt generation. PCI Express endpoints support 64-bit memory addressing capability in prefetchable memory address space, though their non-prefetchable memory address space is permitted to map the below 4 GByte boundary. Both types of endpoints implement Type 0 PCI configuration headers and respond to configuration transactions as completers. Each endpoint is initialized with a deviceID (requester ID or completer ID) which includes a bus number, device number, and function number. Endpoints are always device 0 on a bus.

Like PCI devices, PCI Express devices may support up to eight functions per endpoint (multi-function endpoint) with at least one function number 0. However, a PCI Express Link supports only one endpoint numbered device 0.

A requester is a device that originates a transaction in the PCI Express fabric. Root complexes 214 and endpoints are requester type devices. A completer is a device addressed or targeted by a requester. A requester reads data from a completer or writes data to a completer. A root complex 214 and endpoints are completer type devices.

A port is the interface between a PCI Express component and a link. Each port can include differential transmitters and receivers (not shown). An upstream port is a port that points in the direction of the root complex. A downstream port is a port that points away from the root complex. An endpoint port is an upstream port. A root complex port is a downstream port. An ingress port is a port that receives a packet. An egress port is a port that transmits a packet.

A switch 220 can be conceptualized as including two or more logical PCI to PCI bridges, each bridge being associated with a switch port. For example, a 4-port switch includes four virtual bridges. These bridges are internally connected. The port of a switch that points in the direction of the root complex is an upstream port. All other ports within the switch point away from the root complex and are considered downstream ports. A switch 220 forwards packets using memory, IO or configuration address based routing. Switches 220 forward all types of transactions from any ingress port to any egress port. Switches 220 can implement two arbitration mechanisms, port arbitration and virtual channel (VC) arbitration, by which the switches determine priority with which to forward packets from ingress ports to egress ports.

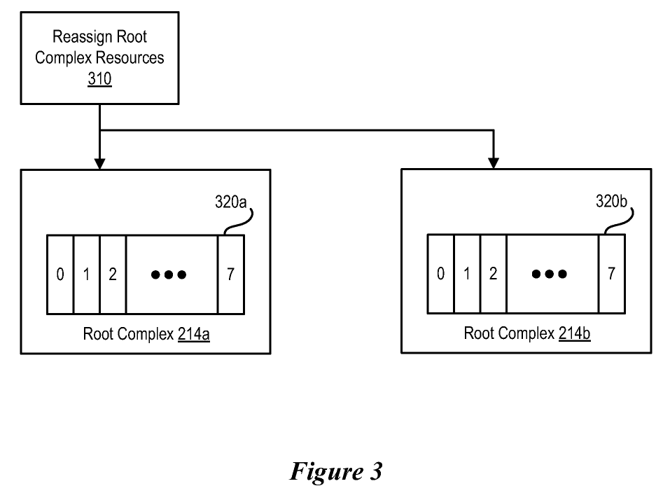

Referring to FIGS. 3, a block diagram of the interaction of a system for reassigning root complex resources with a plurality of root complexes is shown. More specifically, the system for reassigning root complex resources 310 is coupled to a plurality of root complexes 214a, 214b. Each root complex includes a plurality of root complex resources 320a, 320b. The root complex resources 320a, 320b include port specific root complex resources (e.g., root complex resource 0). The port specific root complex resources correspond to respective ports of each of the root complexes 214a, 214b.

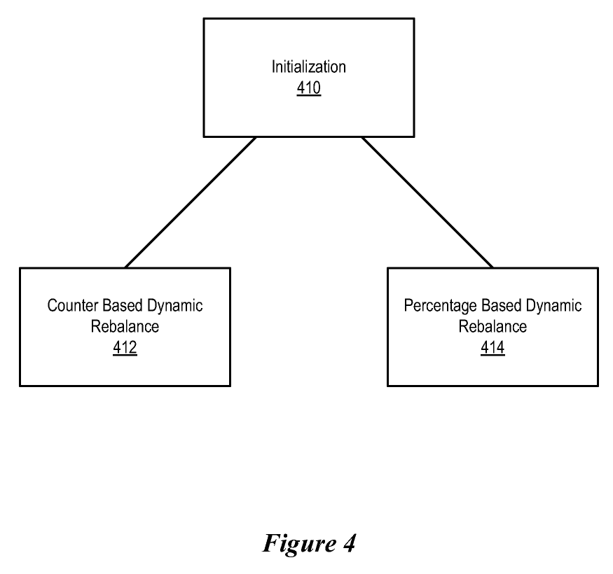

FIG. 4 shows a flow chart of the operation of a system for reassigning root complex resources. More specifically, the system for reassigning root complex resources includes an initialization operation 410 as well as one or more dynamic rebalance operations 412. The rebalance operations 412 can include for example, a counter based dynamic rebalance operation as well as a percentage based dynamic rebalance operation.

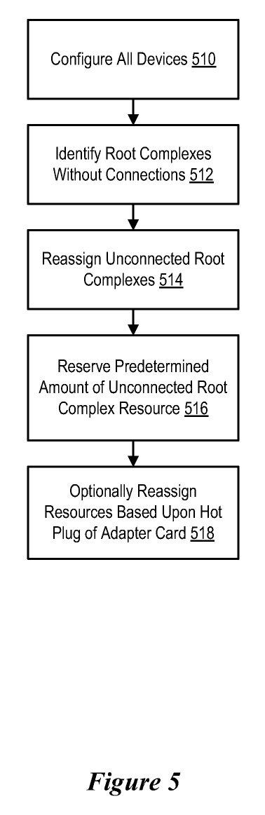

FIG. 5 shows a flow chart of the operation of an initialization operation of an initialization portion of a system for reassigning root complex resources 310. More specifically, at initialization, system firmware stored within the non-volatile memory of the system 200 and executed by the processor or other hardware devices, configures all the devices (e.g., all switches, bridges and endpoints) in the system 200 at step 510. Next the system for reassigning root complex resources identifies root complexes (or ports within root complexes) without devices connected downstream at step 512. For the root complexes 214 that have no connected devices (e.g., root complex 214b), resources from those root complexes 214 are reassigned to the root complexes that have devices attached (e.g., root complex 214a) at step 514.

While performing the reassign operation, the system for reassigning root complex resources 310 reserves a predetermined amount of unconnected root complex resource for potential later use (such as for when a device is hot plugged downstream of the unconnected root complex at step 516. Unlike bifurcation, the root complex from which resources are reassigned remain available with just enough resources set aside in case an adapter card is hot plug added to the root complex 214. At step 518, the system for reassigning root complex resources 200 can optionally can move or reassign resources depending on what type of devices are coupled downstream of a corresponding root complex.

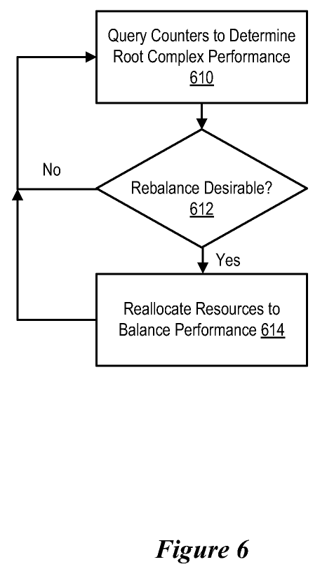

FIG. 6 shows a flow chart of the operation of a counter based dynamic rebalance operation 412 of a system for reassigning root complex resources. More specifically, during a counter based dynamic rebalance operation 412 the system 310 queries performance counters to determine root complex performance at step 610. Next, based upon predetermined performance metrics, the system determines whether a rebalance operation is desirable at step 612. If such a rebalance operation is desirable then the system reallocates resource to rebalance performance of the root complexes at step 614 and then returns to step 610 to continue monitoring root complex performance. If the system 310 determines that a rebalance operation is not desirable, then the system 310 returns to step 610 to continue monitoring root complex performance.

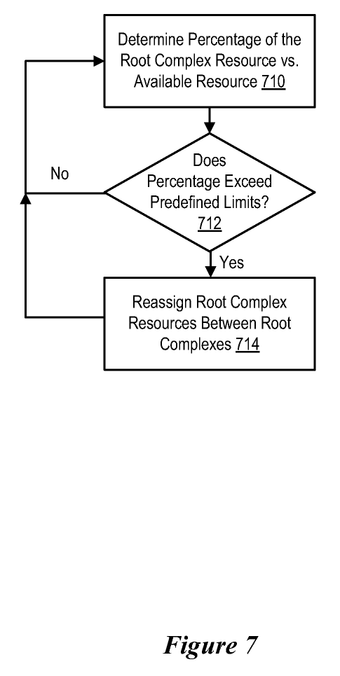

FIG. 7 shows a flow chart of the operation of a percentage based dynamic rebalance operation 414 of a system for reassigning root complex resources 310. More specifically, during a percentage based dynamic rebalance operation 412, the system 310 determines a percentage of used root complex resource versus available root complex resource at step 710. Next, based upon predetermined percentage based performance metrics, the system determines whether a rebalance operation is desirable at step 712. If such a rebalance operation is desirable then the system reallocates resource to rebalance performance of the root complexes at step 714 and then returns to step 710 to continue monitoring root complex performance. If the system 310 determines that a rebalance operation is not desirable, then the system 310 returns to step 710 to continue monitoring root complex performance.

With both the counter based dynamic rebalance operation and the percentage based dynamic rebalance operation, a user has an option of disabling the dynamic rebalance as well as an option of setting the predetermined values to disable the dynamic rebalance or to set forth how aggressively the system 310 should manage dynamic rebalancing of the root complex resources. For example, the predetermined values can identify minimum resources to leave for unused Root Complex, how often to check counters and reallocate, or how much to reallocate per modification.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The block diagrams in the Figures illustrate the architecture, functionality, and operation of possible implementations of systems and methods according to various embodiments of the present invention. It will also be noted that each block of the block diagrams, and combinations of blocks in the block diagrams, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for assigning root complex resources within a computer system comprising:
identifying root complexes within the computer system, each of the root complexes comprising respective root complex resources, each of the root complex resources being either used root complex resources and unused root complex resources;
identifying available root complex resources within the computer system based upon whether the root complex resources are used or unused; and,
reassigning unused root complex resources to root complexes having used root complex resources.

2. The method of claim 1 further comprising:
reserving portions of the unused root complex resources when reassigning unused root complex resources.

3. The method of claim 1 further comprising:
monitoring performance of the root complexes during operation of the computer system; and,
reassigning unused root complex resources if the performance of used root complexes corresponds to predetermined thresholds.

4. The method of claim 3 wherein:
the monitoring includes a counter based monitoring, the counter based monitoring comprising comparing root complex performance counters to predetermined thresholds.

5. The method of claim 3 wherein:
the monitoring includes a percentage based monitoring, the percentage based monitoring comprising comparing used root complex resources to available root complex resources.

6. The method of claim 1 further comprising:
resetting root complex resources if a device is attached to a root complex having unused root complex resources.

7. A system comprising:
a processor;
a plurality of root complexes coupled to the processor; and,
a computer-usable medium embodying computer program code, the computer program code comprising instructions executable by the processor and configured for:
identifying root complexes within the computer system, each of the root complexes comprising respective root complex resources, each of the root complex resources being either used root complex resources and unused root complex resources;
identifying available root complex resources within the computer system based upon whether the root complex resources are used or unused; and,
reassigning unused root complex resources to root complexes having used root complex resources.

8. The system of claim 7 wherein the instructions are further configured for:
reserving portions of the unused root complex resources when reassigning unused root complex resources.

9. The system of claim 7 wherein the instructions are further configured for:
monitoring performance of the root complexes during operation of the computer system; and,
reassigning unused root complex resources if the performance of used root complexes corresponds to predetermined thresholds.

10. The system of claim 9 wherein:
the monitoring includes a counter based monitoring, the counter based monitoring comprising comparing root complex performance counters to predetermined thresholds.

11. The system of claim 9 wherein:
the monitoring includes a percentage based monitoring, the percentage based monitoring comprising comparing used root complex resources to available root complex resources.

12. The system of claim 7 wherein the instructions are further configured for:
resetting root complex resources if a device is attached to a root complex having unused root complex resources.

13. A system comprising:
a processor;
a plurality of root complexes coupled to the processor, each of the root complexes comprising respective root complex resources, each of the root complex resources being either used root complex resources and unused root complex resources; and,
a system for assigning root complex resources, the system for assigning root complex resources comprising
a module for identifying root complexes within the computer system;
a module for identifying available root complex resources within the computer system based upon whether the root complex resources are used or unused; and,
a module reassigning unused root complex resources to root complexes having used root complex resources.

14. The system of claim 13 wherein the system for reassigning root complex resources further comprises:
a module for reserving portions of the unused root complex resources when reassigning unused root complex resources.

15. The system of claim 13 wherein the system for reassigning root complex resources further comprises:
a module for monitoring performance of the root complexes during operation of the computer system; and,
a module for reassigning unused root complex resources if the performance of used root complexes corresponds to predetermined thresholds.

16. The system of claim 15 wherein:
the module for monitoring includes a module for performing a counter based monitoring, the counter based monitoring comprising comparing root complex performance counters to predetermined thresholds.

17. The system of claim 15 wherein:
the module for monitoring includes a module for performing a percentage based monitoring, the percentage based monitoring comprising comparing used root complex resources to available root complex resources.

18. The system of claim 13 wherein the system for reassigning root complex resources further comprises:
a module for resetting root complex resources if a device is attached to a root complex having unused root complex resources.
